(19) United States
(12) Patent Application Publication
(10) Pub. No.: US 2023/0304738 A1
(43) Pub. Date: Sep. 28, 2023

(54) AGITATION DEVICE AND METHOD FOR MELTING FURNACE AND MELTING FURNACE

(71) Applicant: ERGOLINES LAB S.R.L., Trieste (IT)

(72) Inventors: Sabrina STROLEGO, Trieste (IT); Stefano DE MONTE, Trieste (IT); Cristiano PERSI, Trieste (IT); Stefano SPAGNUL, Trieste (IT)

(21) Appl. No.: 18/006,824

(22) PCT Filed: Aug. 3, 2021
(86) PCT No.: PCT/EP2021/000090

§ 371 Date: Jan. 25, 2023

(30) Foreign Application Priority Data
Aug. 4, 2020 (IT) 102020000019186

(51) Int. Cl. F27B 3/10; F27D 27/00; B22D 11/115

(52) U.S. Cl. CPC F27B 3/10; F27D 27/00; B22D 11/115; F27D 2003/0039

(57) ABSTRACT

Electromagnetic agitation device and control method of electromagnetic agitation device for melting furnace of metallic material, in which the electromagnetic agitation device includes series of elements of generation of the force field controlled in an independent or coordinated way with respect to one another for generation of different movements of the molten metallic material contained inside the furnace.

### TECHNICAL FIELD

The present invention relates to a steel agitation device and method for melting furnace according to the characteristics of the pre-characterizing part of the main claims. Furthermore, the present invention relates to a furnace comprising the device thus made.

### PRIOR ART

In the field of the production of metal products, the use is known of recycled metallic materials which are melted in a melting furnace and are subsequently cast into molds or ingot molds in order to obtain workable metal elements for the production of finished or semi-finished products. The recycled metallic materials are introduced into the melting furnace in a solid state in the form of scrap or in the form of pellets and the supply of energy by the furnace allows the melting temperature to be reached of the recycled metallic materials, which progressively melt forming metal in the liquid state. During the melting and when the melting is reached, measurements of the metal in the liquid state are carried out in order to identify its chemical composition and subsequently introduce additives to correct the composition until the desired composition is reached. For example, the metal in the liquid state could be steel. Various types of melting furnaces are known, such as for example Electric Arc Furnaces, known as EAF, induction furnaces, burner furnaces.

The use of electromagnetic agitation devices for furnaces is also known, known as stirrers, which, by means of the generation of electromagnetic fields, induce a movement of the metal in the liquid state, favoring a more rapid melting of the recycled metallic materials, increasing the electrical efficiency as a result of a better transmission of energy from the electrodes to the metal in the liquid state in the case of EAF furnaces, improving the homogenization of the metal in the liquid state contained in the furnace and thus obtaining improved productivity.

The application WO 2012/034586 describes an apparatus for electromagnetic stirring of molten steel in an electric arc furnace, which comprises two electromagnetic stirring units, a power supply unit and a control unit. The two stirrers are mounted on an external bottom surface of the electric arc furnace at opposite sides with respect to a central position of the bottom surface. The power supply unit is operatively connected to the two electromagnetic stirring units and the control unit is operatively connected to the power supply unit to control the functioning of the two electromagnetic stirrers. In one embodiment each of the two electromagnetic stirring units has a core with separate coils wound around the core. In one embodiment the cores have a shape with one or more folds for adaptation to the shape of the external bottom surface of the furnace. The two electromagnetic stirring units can be controlled to function as a single unit with parallel connection of the two units which induce stirring in the same direction or in opposite directions to induce a circular movement on the molten steel. The application GB 1 067 386 describes an electromagnetic stirring device for a direct current electric arc melting furnace. The furnace comprises electrodes driven in direct current of which at least one first electrode is installed inside the furnace and at least one second electrode has a polarity opposite to the one of the first electrode and is positioned in a different position on the bottom of the furnace, thus creating an anode and a cathode which, being fed in direct current, cause a passage of direct current through the metal to be melted in order to melt and mix the metal. The stirring device comprises at least one direct current electromagnet which is mounted in the central portion of the bottom of the furnace so as to produce radial magnetic lines of force from the central portion of the bottom of the furnace to an external shell of the furnace and vice versa thus causing stirring of the molten metal as a result of the reciprocal interactions between the currents flowing through the molten metal and the magnetic fields produced by this electromagnet. The effect obtained is an upward thrust of the molten metal in some first points and downward in second points interspersed with the first points, generating a circular motion of the molten metal. In one embodiment there is the central electromagnet on the bottom and further electromagnets arranged on the side walls separate and distinct with respect to the central electromagnet on the bottom of the furnace.

The application DE 33 09 498 describes an electromagnetic mixer for cast steel which can be used in melting furnaces, ladles and other containers. The electromagnetic mixer is arranged on the bottom of the furnace and can have an arched shape to adapt to the bottom of the furnace. The electromagnetic mixer has a circular and internally hollow plan shape with obtainment of a toroid. Inside the toroid there is a conductive surface above which a series of pairs of generating coils are arranged. Each pair of coils comprises a first coil and a second coil fed with mutually shifted currents. Furthermore, the series of pairs of coils is divided into two groups in which a first group of pairs of coils affects a first 180-degree arc or a first semicircle of the toroidal shape and a second group of pairs of coil involves a second 180-degree arc or a second semicircle of the toroidal shape without overlapping of the two arcs which are thus arranged one after another covering the entire circumference of the toroid. The first group of coils and the second group of coils can be connected so as to generate a concordant agitation action to obtain a rotary motion along the entire circumference of the furnace or they can be connected so as to generate an opposite agitation to obtain a first rotary motion in a first portion of the furnace and a second opposite rotary motion in a second portion of the furnace for cleaning the surface of the molten steel bath contained in the furnace.

The application CN 106 914 183 describes a stirrer for furnace for molten aluminum in which the stirrer is arranged on the bottom of the furnace to generate an electromagnetic force of rotation with a vertical component for formation of a spiral motion in the molten aluminum. The stirrer comprises a series of electromagnetic field generating devices which are arranged on a horizontal non-ferromagnetic circular-base plate in a configuration in which the generating devices are positioned on the base plate symmetrically with central symmetry along the circumference. Each generation device includes a ferromagnetic core and a coil wound around the core on a horizontal plane for the generation of a field facing upwards, that is towards the bottom of the furnace.

The application WO 2020/020478 describes a detection system and method for detecting a melting condition of metallic materials inside a furnace in order to control an electromagnetic stirring device arranged at the bottom of the furnace. The electromagnetic stirring device comprises a row of coils which are arranged one after another according to a direction of development along a longitudinal axis which essentially corresponds to the direction of longitudinal development of the furnace or to the preferential direction of agitation induced in the metal in the liquid state towards the tapping hole of the furnace. The thrust effect of the metal flow in the liquid state in a direction oriented towards the tapping hole is obtained by means of an appropriate phase shift between the currents which feed the coils arranged one after another on the longitudinal axis. Each coil of the stirring device consists of an essentially quadrangular shape winding, according to a plan view, in which the coil develops vertically for a certain height so as to define a closed path of the driving current such as to generate a field of force oriented according to an orthogonal direction with respect to the quadrangular shape.

### Problems of Prior Art

As previously explained, the use is known of electromagnetic agitation devices for furnaces, known as stirrers. The use of these systems is necessary since the melting process by means of the furnace electrodes causes an uneven melting and heating of the metallic material contained in the furnace, with the consequence that there are hotter areas and less hot areas. This lack of homogeneities in the heating of the material is a problem as it extends the melting times and also requires a higher energy consumption to obtain a complete and homogeneous melting of the bath of molten metallic materials contained in the furnace. Further problems are also related to the uniformity of the chemical composition of metallic materials in the molten state as the bath of metallic materials in the molten state has a large surface extension while the addition of correctives to the chemical composition generally occurs in localized areas.

Furthermore, particularly with regard to applications in furnaces with a continuous charging system, it is necessary to consider the fact that the charging takes place in loading areas which are positioned far from the electrodes for supplying the melting energy of the scrap or of the material to be melted. This aspect involves considerable problems from the point of view of the homogenization of the heat distribution inside the metal bath internally to the furnace with the consequence that both problems of localized heating points and also the onset of cold points which slow down the heating process occur. It is therefore necessary to carry out a mixing of the bath of metallic materials in the molten state contained in the furnace.

The current systems for stirring the bath of molten metallic materials contained in the furnace, although partially solving these problems, are mostly affected by further problems as they are normally not configurable except as regards the frequency of the stirring magnetic field applied and its power. On the contrary, the prior art systems are not effective in providing different mixing methods, for example depending on the presence of localized cold points, as they do not allow any adequate configurability of the mixing methodology, for example to vary the mixing directions or the type of mixing adopted. Consequently, also in the case in which electromagnetic mixing systems are adopted of the bath of metallic materials in the molten state contained in the furnace, in order to provide chemical heating energy oriented and localized towards the cold points present in the bath of metallic materials in the molten state, the need remains to use gas burners or oxygen or carbon injection lances or other localized heat supply systems.

### Aim of the Invention

Aim of the present invention is to provide an agitation device and method for steel for melting furnaces which allows high configurability in order to guarantee an efficient agitation process of the bath of metallic materials in the molten state with consequent reduction of the melting times of the scrap and obtention of a better degree of homogenization.

### Concept of the Invention

The aim is achieved by the characteristics of the main claim. The sub-claims represent advantageous solutions.

### Advantageous Effects of the Invention

The solution according to the present invention, through the considerable creative contribution the effect of which constitutes an immediate and not negligible technical progress, has various advantages.

The steel agitation device and method for melting furnaces according to the present invention is highly adaptable to different melting conditions present in the furnace, such as for example the presence of localized cold points, particularly in the cases of melting furnaces provided with lateral charging systems of the metal scrap to be melted, allowing an adaptability of the direction of agitation and of the movements induced in the bath of metallic materials in the molten state in order to eliminate the presence of such cold points in different areas of the furnace.

Furthermore, the inventive solution allows a better operation of the furnace during the tapping phase of the molten metal from the furnace to the ladle since the formation of vortices which lead to the transfer of slag to the ladle is eliminated and the presence of the slag itself in the ladle is reduced. Indeed, thanks to the inventive system, during the tapping phase it is possible to configure and operate the inventive system in such a way that the slag is pushed into areas distant from the tapping mouth of the furnace, avoiding or considerably reducing the exit of slag from the furnace.

Advantageously, a greater homogenization is obtained of the bath of metallic materials in the molten state, favoring a reduction of the melting times with consequent benefits also from the economic point of view due to the greater efficiency of the melting process obtained.

Indeed, the melting of recycled metallic materials occurs in a more uniform and efficient way, with a reduction in the phenomena of “cave-in” and breakage of the electrodes of the electric arc furnace. The melting is also facilitated of any large metallic materials thanks to a better distribution of heat and thanks to the establishment of convective heat exchange phenomena in addition to those by conduction, also reducing the presence of non-melted scrap at the slagging door or at the tapping hole, improving the rate of spontaneous openings. As a result, there is also less need for accurate stratification of the scrap in the charging basket in the furnace.

Furthermore, thanks to a greater homogenization of the bath of molten metallic materials, the stability of the electric arc is achieved more quickly and the transmission of energy to the molten metal bath is more efficient, as a result of the reduction of energy losses. As regards the case of application on electric arc furnaces, as a result of the improved electrical efficiency there is also lower electrical consumption and also the consumption of the electrodes is slower.

Advantageously, the increase in the reaction kinetics improves the decarburization rate of the molten metal bath by a factor of two, reducing oxygen consumption to obtain the same degree of decarburization. In addition, the lower oxygen supply reduces the oxidation of Fe and Mn, increasing the final yield and chemical reduction of the slag, which is less aggressive on refractories, extending their useful life, including the refractories of the tapping hole. The formation of foamy slag is favored. The oxygen content when tapping is lower and this leads to a reduction in the use of deoxidants in the ladle.

Furthermore, the steel bath is homogeneous. The samples taken for chemical analysis and temperature measurements are representative of the entire molten bath, thus requiring a smaller number of samples. The slag is not overheated or partially melted. The more uniform temperature of the bath and of the slag reduces the wear of the refractories.

Finally, as previously explained, the final productivity of the furnace is increased thanks to the improvement of the chemical yield and reduction of processing times. The opening rate of the porous partitions for injection of gas into the ladle is improved, reducing the risk of failure to connect with the continuous casting sequence. The formation is reduced of vortices during tapping and passage of the slag from the furnace into the ladle.

### DESCRIPTION OF THE DRAWINGS

An embodiment solution is described hereinafter with reference to the attached drawings to be considered as a non-limiting example of the present invention in which:

FIG. 1 schematically represents a melting furnace in which the agitation device is applied according to the present invention.

FIG. 2 represents a perspective view of the agitation device according to the present invention.

FIG. 3 represents a plan view of the agitation device according to the present invention.

FIG. 4 represents a view illustrating a possible arrangement of the agitation device on a furnace.

FIG. 5 and FIG. 6 represent views illustrating the effect of the agitation device according to the present invention on the bath of metallic materials in the molten state within the furnace in an operating mode of linear type.

FIG. 7 represents a view illustrating the effect of the agitation device according to the present invention on the bath of metallic materials in the molten state within the furnace in an operating mode of linear type with motion reversal.

FIG. 8 represents a view illustrating the effect of the agitation device according to the present invention on the bath of metallic materials in the molten state within the furnace in a further linear operating mode.

FIG. 9 represents a view illustrating the effect of the agitation device according to the present invention on the bath of metallic materials in the molten state within the furnace in a further linear operating mode with motion reversal.

FIG. 10 and FIG. 11 represent views illustrating the effect of the agitation device according to the present invention on the bath of molten metallic materials within the furnace in a further linear operating mode, in which FIG. 11 is a representation of the section of the furnace indicated with A-A in FIG. 10.

FIG. 12 represents a view illustrating the effect of the agitation device according to the present invention on the bath of metallic materials in the molten state within the furnace in an exemplary operating mode of the rotary type.

FIG. 13 represents a plan view of the agitation device according to the present invention made according to a different embodiment.

FIG. 14 represents a view of one of the elements of the inventive agitation device.

FIG. 15 represents a plan view of a different embodiment of the agitation device according to the present invention.

FIG. 16 represents a plan view of a different embodiment of the agitation device according to the present invention.

FIG. 17, FIG. 18, FIG. 19, FIG. 20, FIG. 21 represent possible reference waveforms for driving the agitation device or stirrer.

### DESCRIPTION OF THE INVENTION

The present invention relates to a steel agitation device and method for melting furnace.

In particular, the steel agitation device is particularly suitable in the case of application on a flat-bath arc type melting furnace.

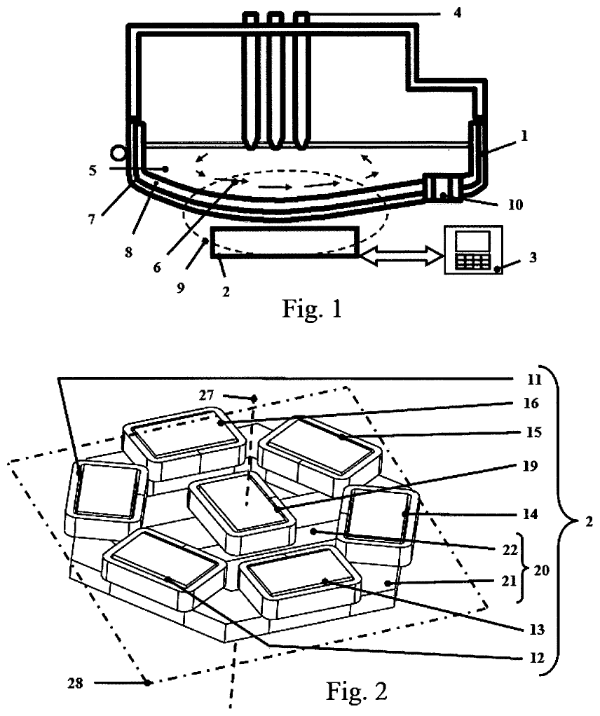

The agitation device or stirrer (2) is applied (FIG. 1) in the proximity of the bottom of a melting furnace (1). The furnace (1) is an electric arc furnace provided with electrodes (4) for the generation of an electric arc for melting the metallic material introduced into the furnace. The metallic material introduced may be in the form of scrap of metallic material or pellets of metallic material. Following the transfer of energy from the electric arc generated by the electrodes (4), the metallic material melts forming a bath of molten metal (5) contained in the furnace (1). The wall (7) of the bottom of the furnace (1) is covered with refractory material (8).

The agitation device or stirrer (2) is controlled by a control unit (3) which manages the different operating modes of the agitation device or stirrer (2), the intensity and frequency of the electric current supplied to the agitation device or stirrer (2).

Following the application of the electric current to the agitation device or stirrer (2), a force field (9) is generated which acts on the molten metal (5) contained in the furnace (1), causing the establishment of movements of the molten metal (5) according to predetermined directions of movement (6) according to the operating modes by which the agitation device or stirrer (2) can be controlled.

The furnace (1) is provided with a tapping hole (10) through which the molten metal (5) can be discharged from the furnace (1) when the molten metal (5) has reached the required conditions of melting temperature and chemical composition, in order to allow its use in the subsequent processing steps, such as for example casting in the form of ingot molds or pit casting or other processing methods which are considered known for the purposes of the present invention.

The agitation device or stirrer (2) comprises a casing (23) containing inside it the elements (11, 12, 13, 14, 15, 16, 19) of generation of the force field (9).

The casing (23) consists of stainless steel panels fixed, for example by means of screws, on a perimetric bearing frame. This solution allows to contain the weight of the stirrer and facilitate maintenance operations and access to the internal windings and to the relative components of the stirrer.

Inside the casing (23) there is a first series (29) of first elements (11, 12, 13, 14, 15, 16) of generation of the force field (9). The first series (29) of first elements (11, 12, 13, 14, 15, 16) of generation of the force field (9) is placed according to a conformation in which the first elements (11, 12, 13, 14, 15, 16) of generation of the force field (9) of the first series (29) are positioned one after another along a closed path. For example, the closed path may have a circular, elliptical, quadrangular, polygonal shape. Furthermore, there is a second series (30) of second elements (19, 31) of generation of the force field (9), The second series (30) of second elements (19) of generation of the force field (9) is placed internally with respect to the closed path defined by the sequence of the first elements (11, 12, 13, 14, 15, 16) of generation of the force field (9) of the first series (29).

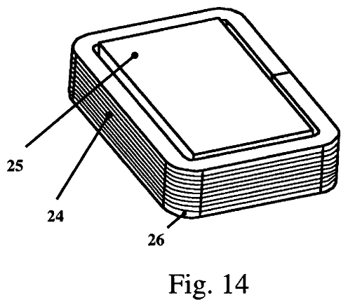

Each element (11, 12, 13, 14, 15, 16, 19) is a component composed of a rectangular magnetic nucleus (25) on which there is a winding (24). Each winding (24) is composed (FIG. 14) of at least one conductor (26) which is preferably an internally hollow conductor defining an internal passage for the flow of cooling fluid, such as for example cooling water. The solution with internally hollow conductor (26) is adopted to minimize the amount of water present under the furnace as much as necessary for safety reasons in the event of vat breakage, as the contact between water and molten steel can lead to explosive phenomena.

Each element (11, 12, 13, 14, 15, 16, 19) is a replaceable component which is easy and quick to remove as each element is made in the form of an encapsulated component and provided with the necessary quick-coupling connection attachments for making connections both as regards the electrical connections for the passage of the driving current in the conductor (26) and as regards the hydraulic connections for the passage of the cooling fluid, such as for example cooling water, inside the cavity of the conductor (26). Advantageously, this solution allows rapid replacement of one or more of the elements (11, 12, 13, 14, 15, 16, 19) in case of failure. The replacement can take place on site and thanks to the use of quick-coupling connection attachments, it can be easily carried out also by non-expert personnel, without the need to remove the agitation device (2) from the furnace (1) to take it to a workshop or send it to the manufacturer.

The nucleus (25) is made of iron-magnetic material, in particular of iron-silicon or carbon steel sheet suitably electrically insulated.

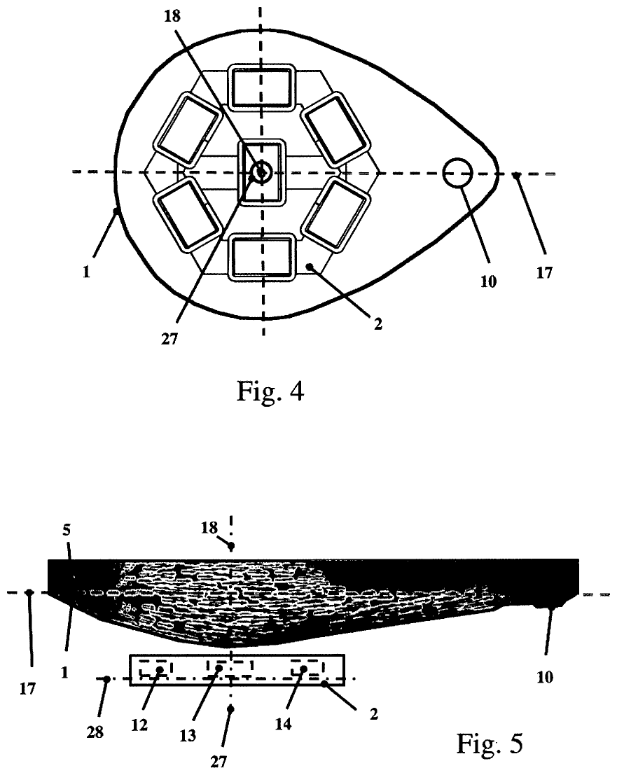

In a first embodiment (FIG. 3, FIG. 4, FIG. 5), the first series (29) of first elements (11, 12, 13, 14, 15, 16) comprises a first component (11), a second component (12), a third component (13), a fourth component (14), a fifth component (15), a sixth component (16) which are placed on a perimetric portion (21) of a support (20) in which the perimetric portion (21) has a regular hexagon shape. The second series (30) of second elements consists of a single central seventh element (19) which is placed on a central portion (22) of the support according to a configuration in which the central portion (22) is placed along an axis of conjunction between opposite vertices of the regular hexagon shape. The first series of first elements (11, 12, 13, 14, 15, 16) is placed in such a way that the subsequent elements of the series are positioned on consecutive adjacent sides of the regular hexagon shape. The major axis of the rectangular shape of the nucleus is placed in such a way as to be parallel to one side of the regular hexagon shape of the perimetric portion (21) of the support (20). In this way, each first element (11, 12, 13, 14, 15, 16) is placed in such a way that it is rotated by an angle corresponding to the angle between the sides of the polygon forming the perimetric portion (21), which in the case of hexagonal shape is an angle of 120 degrees.

In a second embodiment (FIG. 13), the first series (29) of first elements (11, 12, 13, 14) comprises a first component (11), a second component (12), a third component (13), a fourth component (14), which are placed on a perimetric portion (21) of a support (20) in which the perimetric portion (21) has a hexagonal shape. The second series (30) of elements consists of a seventh central component (19) placed on a respective central portion (22) of the support. The first series of first elements (11, 12, 13, 14) is placed in such a way that the subsequent elements of the series are positioned one after another along the support according to an arrangement of the elements in “+” shape. The major axis of the rectangular shape of the nucleus is placed in such a way as to be orthogonal with respect to the sides forming the “+” shape of the first series of first elements (11, 12, 13, 14). In this way, each first element (11, 12, 13, 14) is placed in such a way that it is rotated by an angle of 90 degrees with respect to the other first adjacent elements of the first series of first elements (11, 12, 13, 14). In the illustrated embodiment (FIG. 13), the perimetric portion (21) has a shape with the regular hexagon arrangement but embodiments will be possible with a non-regular hexagon having an elongated shape to have a greater spacing with respect to the center of at least one of the first elements, or of two of the first elements, in such a way as to adapt and correspond to a more elongated shape of the furnace (1) to cover a more extended area along a direction between one furnace side in correspondence with which the supply of metallic materials to be melted in the form of pellets occurs and one opposite furnace side in correspondence with which there is the tapping hole (10).

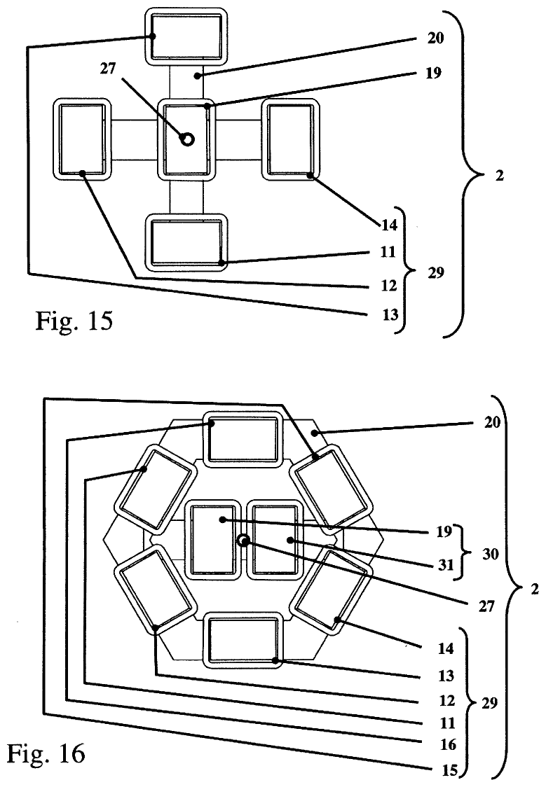

In a third embodiment (FIG. 15), the first series (29) of first elements (11, 12, 13, 14) comprises a first component (11), a second component (12), a third component (13), a fourth component (14), which are placed on a cross-shaped support (20) including a first arm and a second arm reciprocally orthogonal. The second series (30) of second elements consists of a seventh central component (19) placed centrally with respect to the cross-shaped conformation of the support (20), that is centrally with respect to the first elements (11, 12, 13, 14) of the first series (29). The first series (29) of first elements (11, 12, 13, 14) is placed in such a way that the subsequent first elements of the first series are positioned one after another along the support according to a cross arrangement. The major axis of the rectangular shape of the nucleus is placed in such a way as to be orthogonal with respect to the arms of the cross shape of the arrangement of the first series of first elements (11, 12, 13, 14). In this way, each first element (11, 12, 13, 14) is placed in such a way that it is rotated by an angle of 90 degrees with respect to the other first adjacent elements of the first series of elements (11, 12, 13, 14). In the illustrated embodiment (FIG. 15), the support (20) has a cross-shaped conformation with equal arms but embodiments will be possible with one arm greater than the other, that is elongated to have a greater spacing with respect to the center of at least one of the first elements, or of two of the first elements, in such a way as to adapt and correspond to a more elongated conformation of the furnace (1) to cover a wider area along a direction between one furnace side in correspondence with which the supply of metallic materials to be melted occurs in the form of pellets and one opposite furnace side in correspondence with which there is the tapping hole (10).

In a fourth embodiment (FIG. 16), the first series (29) of first elements (11, 12, 13, 14, 15, 16) comprises a first component (11), a second component (12), a third component (13), a fourth component (14), a fifth component (15), a sixth component (16) which are placed on a perimetric portion (21) of a support (20) in which the perimetric portion (21) has a regular hexagon shape. The second series (30) of elements consists of a seventh component (19) and a further eighth component (31) which are placed on a central portion of the support and symmetrically with respect to the central axis of the agitation device (27). The central portion is placed along a junction axis between opposite vertices of the regular hexagon shape. The first series (29) of first elements (11, 12, 13, 14, 15, 16) is placed in such a way that the subsequent first elements of the first series are positioned on consecutive adjacent sides of the regular hexagon shape. The major axis of the rectangular shape of the nucleus is placed in such a way as to be parallel to one side of the regular hexagon shape of the perimetric portion of the support (20). In this way, each first element (11, 12, 13, 14, 15, 16) is placed in such a way that it is rotated by an angle corresponding to the angle between the sides of the polygon forming the perimetric portion (21), which in the case of hexagonal shape is an angle of 120 degrees.

In general, the agitation device (2) or stirrer therefore comprises a number “n” of elements (11, 12, 13, 14, 15, 16, 19, 31) placed according to the described configurations. Each of the elements (11, 12, 13, 14, 15, 16, 19, 31) is supplied by a corresponding single-phase power supply and the ensemble of single-phase power supplies is controlled in a coordinated way to provide a corresponding ensemble of currents, one for each of the elements (11, 12, 13, 14, 15, 16, 19, 31), in which the currents are reciprocally appropriately shifted with respect to each other in order to generate different configurations of the agitation magnetic force field (9). In particular, a control unit (2) manages the phase shifts according to a set of operating modes which can be selected manually or automatically according to process execution procedures or automatically according to the expected process parameters or automatically according to measured process parameters or a combination of these modes.

Therefore, in general, the agitation device or stirrer (2) can work in different operating modes, under the control of the control unit (3) which can be provided with programs for activating and switching between the different operating modes according to the detected or estimated conditions of the melting process, such as for example in the case of feeding of metallic materials to be melted, proceeding of the melting process, increase in the melting percentage, imminent tapping phase.

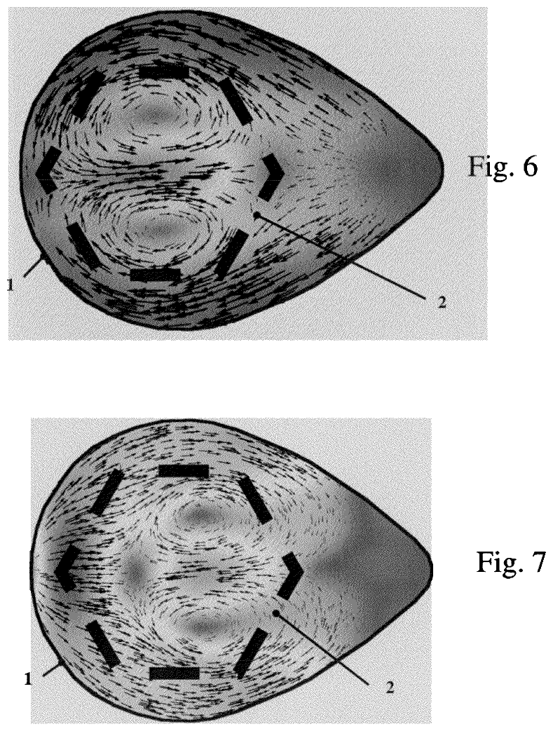

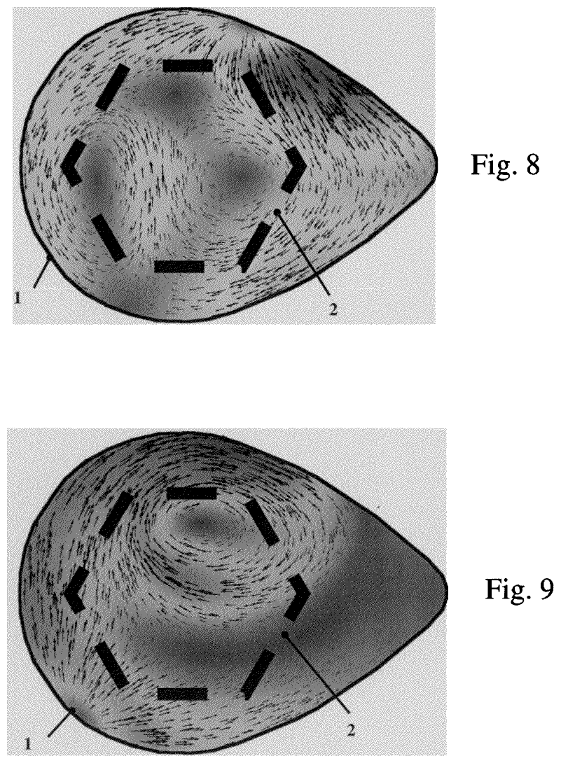

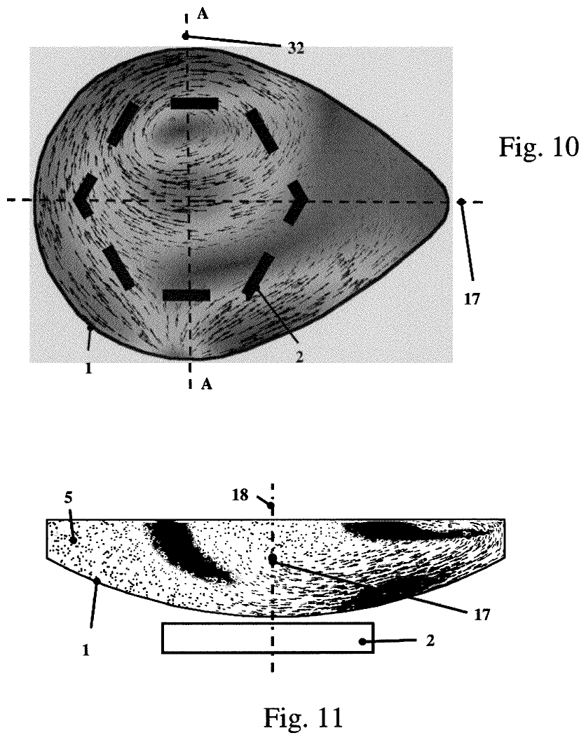

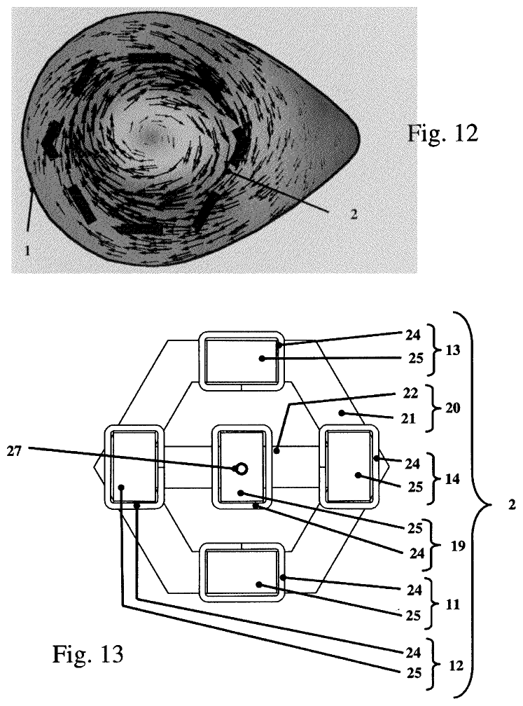

In the illustrative figures of the flows generated (FIG. 5, FIG. 6, FIG. 7, FIG. 8, FIG. 9, FIG. 10, FIG. 11, FIG. 12), the length of the directional arrows is proportional to the speed of the stirrer-induced flow of molten metal and the higher intensity of grayscale coloring corresponds to a faster speed with respect to a lower intensity of grayscale coloring.

A first operating mode, called linear, is used to improve thermal uniformity by bringing the cold steel from the lower part of the furnace to the surface or to heat the tapping area where the tapping hole (10) is present to facilitate the opening of the hole itself during tapping. Furthermore, this mode allows the slag to be moved towards the slagging door, freeing the bath during the tapping phase. This action, combined with the elimination of vortices during tapping, causes a drastic reduction in the passage of slag in the ladle. This method is particularly suitable also in case the metal scrap to be melted is loaded in the center of the furnace (1) or in any case along its axis, such as for example in the so-called furnaces in which the loading takes place by means of a bridge crane or by means of a pre-heated charge basket positioned above the furnace itself and exposed to hot fumes coming from the bath contained in the furnace.

The agitation device or stirrer (2) is placed (FIG. 4, FIG. 5) below the furnace (1), preferably according to a configuration in which a central axis (27) of the agitation device is positioned in the proximity of a central area of the bath of the furnace (1) in such a way that at least one of the first elements of the first series of elements (11, 12, 13, 14, 15, 16) is placed for the generation of the respective force field (9) in an area between the central area of the bath of the furnace (1) and the area of the furnace (1) in correspondence with which there is the tapping hole (10). If there is a second series (30) of second elements (19, 31), such as for example a single second central element consisting of the seventh component (19), then, preferably, the seventh component (19), which is central to the first series of first elements, is positioned in the proximity of a central area of the bath of the furnace (1).

In general at least one of the first elements (11, 12, 13, 14, 15, 16) of the first series (29) is preferably placed for the generation of the respective force field (9) in an area between the central area of the bath of the furnace (1) and the area of the furnace (1) in correspondence with which there is the tapping hole (10) while at least another one of the first elements (11, 12, 13, 14, 15, 16) of the first series (29) is placed for the generation of the respective force field (9) in an opposite zone of the furnace (1) with respect to the zone in correspondence with which there is the tapping hole (10). Further first elements of the first series (29) of first elements (11, 12, 13, 14, 15, 16) are placed for the generation of the respective force field (9) laterally with respect to a longitudinal axis (17) of the furnace (1) which is an axis passing through the center of the tapping hole (10) and orthogonal with respect to a central axis (18) of the furnace, that is central with respect to the bottom of the furnace and to the respective bath and orthogonal to a transverse axis (32) of the furnace. Longitudinal axis (17), central axis (18) and transverse axis (32) of the furnace form a set of three Cartesian axes with the center of the set of three axes coinciding with a central point of the furnace (1).

For example, the central portion (22) of the support (20) of the agitation device or stirrer (2) can be made in the form of a support arm placed along a diameter of the essentially circular configuration of the perimetric portion (21) of the support (20) and this arm can be placed parallel to the longitudinal axis (17) of the furnace (1) with a seventh central component (19) positioned as previously described, that it according to an arrangement in which the seventh central component (19) of the second series (30) of elements is positioned in the proximity of a central area of the bath of the furnace (1).

With reference to the previously described linear operating mode, in order to obtain this effect, for example, a first example of operation of the agitation device or stirrer (2) can be considered according to the linear mode, in which the driving configuration of the elements (11, 12, 13, 14, 15, 16, 19) of generation of the force field (9) is shown in table 1.

TABLE 1
example of driving of the elements in linear mode, direct LIN01

| | Driving current | Three-phase |
|---|---|---|
| Element of generation | phase shift | tern reference |
| of the force field | [°] | R = 0°, S = 120°, T = 240° |
| First component (11) | 0 | R |
| Second component (12) | 0 | R |
| Third component (13) | Not in operation | Not in operation |
| Fourth component (14) | 120 | S |
| Fifth component (15) | 120 | S |
| Sixth component (16) | Not in operation | Not in operation |
| Seventh component (19) | 240 | T |

In practice, in this configuration the elements (11, 12, 13, 14, 15, 16, 19) of generation of the force field (9) are driven with a three-phase current tern according to a configuration in which the first component (11) and the second component (12) are driven with a first 0-degree phase shift reference current, the seventh component (19) is driven with a 120-degree shifted current with respect to the reference current with which the first component (11) and the second component (12), the fifth component (15) and the sixth component (16) are driven with a 240-degree shifted current with respect to the reference current with which the first component (11) and the second component (12) are driven. The third component (13) and the sixth component (14) are not current driven.

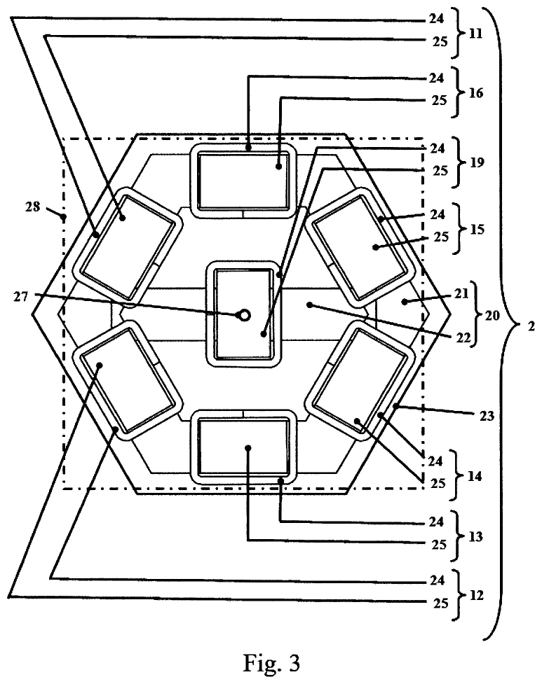

In a first example of operation of the agitation device or stirrer (2) according to a linear mode, with reference to the first embodiment illustrated (FIG. 2, FIG. 3) the first elements of the first series (29) of first elements (11, 12, 13, 14, 15, 16) and the second elements of the second series (30) of second elements (19) are controlled in such a way as to achieve an effect (FIG. 5, FIG. 6) on the bath of the molten metal (5) contained in the furnace (1) in which:
considering the median section (FIG. 5) of the furnace (1) on a vertical plane passing through the tapping hole (10), in the region near the bottom of the furnace (1) and, therefore, closer to the stirrer, the agitation device or stirrer (2) controlled to operate in linear stirring mode, induces a movement in the direction of migration of the magnetic field and therefore of thrust of the molten metal (5) along the direction of the longitudinal axis (17) of the furnace (1), for example according to a direction oriented towards the tapping hole (10);
considering the median section (FIG. 5) of the furnace (1) on a vertical plane passing through the tapping hole (10), the flow of molten metal (5) is then diverted towards the surface of the bath for the deviation action given by the walls of the furnace (1);
considering the median section (FIG. 5) of the furnace (1) on a vertical plane passing through the tapping hole (10), the flow of molten metal (5) proceeds in the direction opposite to the thrust direction up to about half of the furnace (1);
considering the median section (FIG. 5) of the furnace (1) on a vertical plane passing through the tapping hole (10), in the remaining half, the surface flow has the same direction as the main thrust flow.
considering the plan view (FIG. 6) of the furnace (1), the effect on the surface of the bath of molten metal (5) is the creation of two large recirculations, symmetrical with respect to the longitudinal plane of symmetry of the furnace, generated from the meeting of the two countercurrent flows described above. The action of these recirculations is the increase in agitation on the sides of the furnace, optimizing thermal and chemical homogenization.

The main effects given by the movement of the fluid represented in this section are:
thermal homogenization between the surface, which is warmer, and the bottom of the furnace, which is colder;
supply of hot steel in the area of the tapping mouth, an action which increases the rate of spontaneous openings of the EBT;
elimination of the vortex which is formed during tapping with consequent reduction of a possible passage of slag in the ladle;
reduction of the quantity of slag above the tapping mouth which is pushed towards the deslagging door, with consequent reduction of the passage of the slag in the ladle.

A linear configuration with motion reversal is further possible with respect to the previous configuration described in table 1. This solution is shown in a second example of operation in table 2. The configurations defined as referring to a motion reversal are configurations which refer to a driving of the elements which is such as to correspond to a generation of induced movement in the bath in which the motion has a direction opposite to the one of a corresponding direct driving configuration.

TABLE 2
example of driving of the elements in linear
mode with reversal, reverse LIN01

| | Driving current | Three-phase |
|---|---|---|
| Element of generation | phase shift | tern reference |
| of the field | [°] | R = 0°, S = 120°, T = 240° |
| First component (11) | 0 | R |
| Second component (12) | 0 | R |
| Third component (13) | Not in operation | Not in operation |
| Fourth component (14) | 240 | T |
| Fifth component (15) | 240 | T |
| Sixth component (16) | Not in operation | Not in operation |
| Seventh component (19) | 120 | S |

Considering the plan view (FIG. 7) of the furnace (1), the effect on the surface of the bath of molten metal (5) is similar to the one (FIG. 6) of the configuration of Table 1, as we have also in this case the creation of two large recirculations, symmetrical with respect to the longitudinal symmetry plane of the furnace, generated by the meeting of two counter-current flows but the direction of the molten steel movements inside the furnace is opposite to the previous example.

Further configurations which correspond to linear operating modes, different from the one previously described, are for example the following.

With reference to the linear operating mode, a third example of operation is shown in table 3, with the driving configuration of the first elements (11, 12, 13, 14, 15, 16, 19) of generation of the force field (9).

TABLE 3
example of driving of the elements in linear mode, direct LIN02

| | Driving current | Three-phase |
|---|---|---|
| Element of generation | phase shift | tern reference |
| of the field | [°] | R = 0°, S = 120°, T = 240° |
| First component (11) | Not in operation | Not in operation |
| Second component (12) | 0 | R |
| Third component (13) | Not in operation | Not in operation |
| Fourth component (14) | Not in operation | Not in operation |
| Fifth component (15) | 120 | S |
| Sixth component (16) | Not in operation | Not in operation |
| Seventh component (19) | 240 | T |

With reference to the linear operating mode, a fourth example of operation of the agitation device or stirrer (2) can be considered in linear mode, in which the driving configuration of the elements (11, 12, 13, 14, 15, 16, 19) of generation of the force field (9) is shown in table 4.

TABLE 4
example of driving of the elements in linear mode, direct LIN03

| | Driving current | Three-phase |
|---|---|---|
| Element of generation | phase shift | tern reference |
| of the field | [°] | R = 0°, S = 120°, T = 240° |
| First component (11) | Not in operation | Not in operation |
| Second component (12) | 0 | R |
| Third component (13) | 0 | R |
| Fourth component (14) | Not in operation | Not in operation |
| Fifth component (15) | 120 | S |
| Sixth component (16) | 120 | S |
| Seventh component (19) | 240 | T |

Considering the plan view (FIG. 8) of the furnace (1), the effect on the surface of the bath of molten metal (5), the configuration shown in the previous table creates a stirring effect on the bath of molten metal within the furnace (1) with the creation of three recirculations.

A linear configuration with motion reversal is also possible with respect to the configuration described in the previous table, to be considered as a fifth example of operation of the agitation device or stirrer (2) in linear mode. This solution is shown in table 5. The configurations defined as referring to a motion reversal are configurations which refer to a driving of the elements which is such as to correspond to a generation of induced movement in the bath in which the motion has a direction opposite to the one of a corresponding direct driving configuration.

TABLE 5
example of driving of the elements in linear
mode with reversal, reverse LIN03

| | Driving current | Three-phase |
|---|---|---|
| Element of generation | phase shift | tern reference |
| of the field | [°] | R = 0°, S = 120°, T = 240° |
| First component (11) | Not in operation | Not in operation |
| Second component (12) | 0 | R |
| Third component (13) | 0 | R |
| Fourth component (14) | Not in operation | Not in operation |
| Fifth component (15) | 240 | T |
| Sixth component (16) | 120 | S |
| Seventh component (19) | 120 | S |

Considering the plan view (FIG. 9) of the furnace (1), the effect on the surface of the bath of molten metal (5), there is the creation of a large recirculation in an asymmetrical position with respect to the axis of the furnace (1).

With reference to the linear operating mode, a sixth example of operation of the agitation device or stirrer (2) in linear mode can be considered, in which the driving configuration of the elements (11, 12, 13, 14, 15, 16, 19) of generation of the force field (9) is shown in table 6.

TABLE 6
example of driving of the elements in linear mode, direct LIN04

| | Driving current | Three-phase |
|---|---|---|
| Element of generation | phase shift | tern reference |
| of the field | [°] | R = 0°, S = 120°, T = 240° |
| First component (11) | 0 | R |
| Second component (12) | Not in operation | Not in operation |
| Third component (13) | Not in operation | Not in operation |
| Fourth component (14) | 120 | S |
| Fifth component (15) | Not in operation | Not in operation |
| Sixth component (16) | Not in operation | Not in operation |
| Seventh component (19) | 240 | T |

With reference to the linear mode of operation, a seventh example of operation of the agitation device or stirrer (2) according to the linear mode can be considered, in which the driving configuration of the elements (11, 12, 13, 14, 15, 16, 19) of generation of the force field (9) is shown in table 7.

TABLE 7
example of driving of the elements in linear mode, direct LIN05

| | Driving current | Three-phase |
|---|---|---|
| Element of generation | phase shift | tern reference |
| of the field | [°] | R = 0°, S = 120°, T = 240° |
| First component (11) | 0 | R |
| Second component (12) | Not in operation | Not in operation |
| Third component (13) | 120 | S |
| Fourth component (14) | 120 | S |
| Fifth component (15) | Not in operation | Not in operation |
| Sixth component (16) | 0 | R |
| Seventh component (19) | 240 | T |

Given the condition of symmetry of the stirrer (2) and of the furnace (1), the image of the effect on the surface of the bath of molten metal (5) is symmetrical with respect to the one reported for the configuration in table 4 (FIG. 8) for the direct driving configuration and three recirculations are created but with opposite directions of rotation with respect to those indicated.

The same considerations also apply to a corresponding linear operating mode with motion reversal with respect to the configuration described in the previous table, to be considered as an eighth example of operation of the agitation device or stirrer (2) in linear mode. This solution is shown in table 8 and the image of the effect on the surface of the bath of molten metal (5) will be symmetrical with respect to the one reported for the configuration of table 5 (FIG. 9).

TABLE 8
example of driving of the elements in linear
mode with reversal, reverse LIN05

| | Driving current | Three-phase |
|---|---|---|
| Element of generation | phase shift | tern reference |
| of the field | [°] | R = 0°, S = 120°, T = 240° |
| First component (11) | 0 | R |
| Second component (12) | Not in operation | Not in operation |
| Third component (13) | 240 | T |
| Fourth component (14) | 240 | T |
| Fifth component (15) | Not in operation | Not in operation |
| Sixth component (16) | 0 | R |
| Seventh component (19) | 120 | S |

With reference to the linear mode of operation, a ninth example of operation of the agitation device or stirrer (2) according to the linear mode can be considered, in which the driving configuration of the elements (11, 12, 13, 14, 15, 16, 19) of generation of the force field (9) is shown in table 9.

TABLE 9
example of driving of the elements in linear mode, direct LIN06

| | Driving current | Three-phase |
|---|---|---|
| Element of generation | phase shift | tern reference |
| of the field | [°] | R = 0°, S = 120°, T = 240° |
| First component (11) | Not in operation | Not in operation |
| Second component (12) | Not in operation | Not in operation |
| Third component (13) | 0 | R |
| Fourth component (14) | Not in operation | Not in operation |
| Fifth component (15) | Not in operation | Not in operation |
| Sixth component (16) | 120 | S |
| Seventh component (19) | 240 | T |

This last configuration is particularly interesting for continuous charging furnaces with lateral charging of the scrap, as it allows to force the flow of liquid steel in the charging area, favoring the melting of the scrap just introduced, as can be also seen from the indication of the flows foreseen within the bath (FIG. 10, FIG. 11). In particular it is highlighted that with this configuration a movement of the molten metal is induced with a direction orthogonal to the longitudinal plane of the furnace.

A similar inverse configuration would have a symmetrical effect to what is represented with reference to the direct configuration.

In general, the exemplary solutions described in the figures and corresponding to the indicated tables of driving configuration of the elements (11, 12, 13, 14, 15, 16, 19) of generation of the force field (9), allow to obtain flow movements of liquid steel affecting the entire steel bath with considerable benefits from the point of view of uniformity of temperature and composition, as well as benefits from an economic point of view for the reduction of the need to apply function power for longer times and for the reduction of the period between one casting and the next.

A second operating mode, called rotary, is used to facilitate melting of the scrap if it is inserted into the furnace not centrally but laterally in correspondence with a position along the sides of the mold. This configuration is advantageous in that it allows liquid metal and, therefore, heat to be applied to the areas where the scrap lies after its insertion into the furnace (1).

In order to obtain this effect, for example, it is possible to use the following configuration for driving the elements (11, 12, 13, 14, 15, 16, 19) of generation of the force field (9).

TABLE 10
example of driving of the elements in rotary mode

| | Driving current | Three-phase |
|---|---|---|
| Element of generation | phase shift | tern reference |
| of the field | [°] | R = 0°, S = 120°, T = 240° |
| First component (11) | 0 | R |
| Second component (12) | 60 | −S |
| Third component (13) | 120 | T |
| Fourth component (14) | 180 | −R |
| Fifth component (15) | 240 | S |
| Sixth component (16) | 300 | −T |
| Seventh component (19) | Not in operation | Not in operation |

In practice, in this configuration the elements (11, 12, 13, 14, 15, 16, 19) of generation of the force field (9) are driven with a three-phase current tern according to a configuration in which the first component (11) is driven with a first 0-degree phase-shift reference current and the successive adjacent components along the previously defined closed path defined by the sequence of first elements (11, 12, 13, 14, 15, 16) of generation of the force field (9) of the first series are in turn driven with currents gradually shifted by 60 degrees with respect to the adjacent element of the sequence of elements.

In the rotary mode, with reference to the first illustrated embodiment (FIG. 2, FIG. 3) the first elements of the first series (29) of elements (11, 12, 13, 14, 15, 16) are controlled in such a way as to generate an effect (FIG. 12) on the bath of molten metal (5) contained in the furnace (1) in which the molten metal is rotated with respect to the central axis of the furnace. This agitation mode is particularly suitable in the case of lateral charging of scrap in the melting furnace since it is able to bring large quantities of hot steel into the scrap area, avoiding the formation of cold air and significantly increasing the melting rates of the scrap itself.

With reference to both the linear operating mode and the rotary operating mode, the inverse operating mode with motion reversal is available, as already explained, in which in order to reverse the direction of migration of the field in the linear configuration or the direction of rotation in the rotary one, a permutation is sufficient of the reference tern of the three-phase system, changing the phase shifts of only a pair of phases, for example RTS or SRT.

Ultimately, the present invention relates to (FIG. 1, FIG. 2, FIG. 5, FIG. 13, FIG. 15, FIG. 16) an electromagnetic agitation device (2) for melting furnace (1) of metallic material, in which the agitation device (2) is installed below the melting furnace (1), in which below is referred with respect to the direction of gravity, the agitation device (2) being installed at a bottom of the melting furnace (1) in such a way that a force field (9) of the electromagnetic agitation device (2) is at least partially situated inside the melting furnace (1) for electromagnetic agitation action on molten metal contained inside the melting furnace (1), in which the agitation device (2) comprises at least one element (11, 12, 13, 14, 15, 16, 19, 31) configured for generation of a respective electromagnetic field, in which the element (11, 12, 13, 14, 15, 16, 19, 31) is composed of a magnetic nucleus (25) on which a winding (24) is present for passage of current and generation of a respective magnetic field, the agitation device (2) comprising a control unit (3) for controlling the agitation device (2) in which the electromagnetic agitation device (2) comprises at least one first series (29) of first elements (11, 12, 13, 14, 15, 16) of generation of the force field (9), which are placed according to a shape in which the first elements (11, 12, 13, 14, 15, 16) of the first series (29) are placed one after another on an assembly plane (28), in which the assembly plane (28) is intended to be parallel to the bottom of the melting furnace (1) when the electromagnetic agitation device (2) is in the installed condition at the bottom of the melting furnace (1), the first elements (11, 12, 13, 14, 15, 16) being placed around a central axis (27) of the agitation device which is an orthogonal central axis with respect to the assembly plane (28). Preferably the first elements (11, 12, 13, 14, 15, 16) are placed along a closed path which develops on the assembly plane (28). For example the first elements (11, 12, 13, 14, 15, 16) of the first series (29) are placed on the assembly plane (28) according to a central symmetry arrangement with respect to the central axis (27) of the agitation device, in which the central axis is centrally passing with respect to the closed path along which the first elements (11, 12, 13, 14, 15, 16) of the first series (29) are placed. In the preferred solution of the present invention, each of the first elements (11, 12, 13, 14, 15, 16) of the first series (29) is placed on the assembly plane (28) according to an arrangement in which each of the first elements (11, 12, 13, 14, 15, 16) is oriented in such a way that a major axis of a quadrangular shape of the magnetic nucleus (25) is tangentially placed with respect to the closed path arrangement of the first series (29) of first elements (11, 12, 13, 14, 15, 16).

In one embodiment (FIG. 13, FIG. 15) the electromagnetic agitation device (2) includes four first elements (11, 12, 13, 14, 15, 16) of the first series (29), in which the four first elements (11, 12, 13, 14) are placed on the assembly plane (28) according to a cross arrangement with a first pair (11, 13) of first elements placed at opposite ends of a first arm of the cross arrangement and a second pair (12, 14) of first elements placed at opposite ends of a second arm of the cross arrangement. For example a cross center between first arm and second arm of the cross arrangement can coincide with the central axis (27) of the agitation device.

In one embodiment (FIG. 3), the electromagnetic agitation device (2) includes six first elements (11, 12, 13, 14, 15, 16) of the first series (29), in which the six first elements (11, 12, 13, 14, 15, 16) are placed on the assembly plane (28) according to a hexagon arrangement with a first pair (11, 14) of first elements placed on a first couple of opposite sides of the hexagonal arrangement, a second pair (12,15) of first elements placed on a second couple of opposite sides of the hexagonal arrangement, a third pair (13, 16) of first elements placed on a third couple of opposite sides of the hexagonal arrangement.

In general, the first elements (11, 12, 13, 14, 15, 16) of the first series (29) are controlled by the control unit (3) in an independent way one another for application of reciprocally shifted alternating currents for generation of the force field (9) in such a way that the force field (9) induces movements on the metallic material contained inside the melting furnace (1), which are configurable according to different sequences of application of the reciprocally shifted alternating currents independently applied on the first elements (11, 12, 13, 14, 15, 16) of the first series (29).

Furthermore, the electromagnetic agitation device (2) can also include one or more further second internal elements (19, 31) of generation of the force field (9), further with respect to the first elements (11, 12, 13, 14, 15, 16) of the first series (29), in which the one or more second internal elements (19, 31) are placed internally with respect to the ensemble of the first elements (11, 12, 13, 14, 15, 16) of the first series (29). In one solution (FIG. 16) the electromagnetic agitation device (2) includes more than one of said further second internal elements (19, 31) of generation of the force field (9), in which said further second internal elements (19, 31) form a second series (30) of second internal elements (19, 31) of generation of the force field (9), which are placed according to a shape in which the second internal elements (19, 31) of the second series (30) are internally placed with respect to the ensemble of the first elements (11, 12, 13, 14, 15, 16) of the first series (29).

However, it will be evident that for the purposes of the present invention also the presence of one single second internal element (19, 31) is sufficient to obtain the previously described operating configurations, the presence of further second elements being possibly useful in order to strengthen the effect of some operating modes of the linear typology described or being possibly useful in furnaces with particularly large longitudinal extension.

The second elements (19, 31) of the second series (30) are preferably controlled by the control unit (3) in an independent way one another for application of reciprocally shifted alternating currents for generation of the force field (9) in such a way that the force field (9) induces movements on the metallic material contained inside the melting furnace (1), which are configurable according to different sequences of application of the reciprocally shifted alternating currents independently applied on the second elements (19, 31) of the second series (30). However, in some operating modes one or more second elements (19, 31) can be controlled with the same driving current.

In general the one or more further second internal elements (19, 31) are controlled by the control unit (3) in an independent way with respect to the first elements (11, 12, 13, 14, 15, 16) of the first series (29) but in some preferred embodiments or in other modes of control of the agitation device (2) the one or more further second internal elements (19, 31) are controlled by the control unit (3) in a coordinated way together with the first elements (11, 12, 13, 14, 15, 16) of the first series (29) for application of reciprocally shifted alternating currents for generation of the force field (9) in such a way that the force field (9) induces movements on the metallic material contained inside the melting furnace (1), which are configurable according to different sequences of application of the reciprocally shifted alternating currents applied in a coordinated way on the one or more further second internal elements (19, 31) of the second series (30) and on the first elements (11, 12, 13, 14, 15, 16) of the first series (29).

In the preferred embodiment of the present invention, the control unit (3) includes a commutation system between at least two operating modes of the electromagnetic agitation device (2), of which:
a first operating mode is a rotary operating mode in which the one or more second internal elements (19, 31) are in a deactivated condition and the first elements (11, 12, 13, 14, 15, 16) are driven with a three-phase tern of currents according to a configuration in which each of the first elements (11, 12, 13, 14, 15, 16) is driven with a respective shifted current with respect to another previous or next element of the first elements (11, 12, 13, 14, 15, 16) with respect to a deposition sequence of the elements on the assembly plane (28), in such a way that the molten metal is in rotational condition around a central axis (18) of the furnace according to a first rotation direction;
a second operating mode is a linear operating mode in which the one or more second internal elements (19, 31) are in an activated condition together with the first elements (11, 12, 13, 14, 15, 16), the one or more second internal elements (19, 31) and the first elements (11, 12, 13, 14, 15, 16) being driven with a three-phase tern of currents according to a configuration in which at least one of the one or more second internal elements (19, 31) is driven with a respective shifted current with respect to corresponding driving currents of one or more elements of the first series (29) of the first elements (11, 12, 13, 14, 15, 16) in such a way that the molten metal is in rotational condition around different rotation zones with generation of more than one different circulation movements inside the furnace in which each circulation movement has a first rotation direction.

The commutation system may include a system of rotary inversion of the motion of the first rotary operating mode in which the system of rotary inversion of the motion controls the shifted driving condition of the first elements (11, 12, 13, 14, 15, 16) in such a way that the molten metal is in rotational condition around the central axis (18) of the furnace according to a second rotation direction which is opposite with respect to the first rotation direction.

The commutation system may include a system of linear inversion of the motion of the second linear operating mode in which the system of linear inversion of the motion controls the shifted driving condition of the first elements (11, 12, 13, 14, 15, 16) and of the one or more second elements (19, 31) in such a way that the molten metal is in rotational condition around said different rotation zones with generation of more than one different circulation movements inside the furnace in which at least one circulation movement has a second rotation direction opposite with respect to the first rotation direction. Each circulation movement can be also provided having a second rotation direction opposite to the first rotation direction.

The present invention also relates (FIG. 1, FIG. 4, FIG. 5) to a melting furnace (1) of metallic material, in which the furnace (1) includes an electromagnetic agitation device (2) placed below with respect to a wall (7) at a bottom of the melting furnace (1) in such a way that a force field (9) of the electromagnetic agitation device (2) is at least partially situated inside the melting furnace (1) for electromagnetic agitation action on molten metal contained inside the melting furnace (1), in which the electromagnetic agitation device (2) is made according to what is described.

The present invention also relates to a control method of an electromagnetic agitation device (2) as described in which the method includes a control phase of the first elements (11, 12, 13, 14, 15, 16) in which the first elements (11, 12, 13, 14, 15, 16) are driven with a three-phase tern of currents according to a configuration in which each of the first elements (11, 12, 13, 14, 15, 16) is driven with a respective shifted current with respect to another previous or next element of the first elements (11, 12, 13, 14, 15, 16) with respect to a deposition sequence of the elements on the assembly plane (28).

In the case of embodiment of the agitation device (2) further comprising one or more further second internal elements (19, 31) of generation of the force field (9) further with respect to the first elements (11, 12, 13, 14, 15, 16) of the first series (29), the method includes a coordinated control phase of the first elements (11, 12, 13, 14, 15, 16) and of the one or more second internal elements (19, 31), in which the one or more second internal elements (19, 31) and the first elements (11, 12, 13, 14, 15, 16) are driven with a three-phase tern of currents according to a configuration in which at least one of the one or more second internal elements (19, 31) is driven with a respective shifted current with respect to corresponding driving currents of one or more elements of the first series (29) of the first elements (11, 12, 13, 14, 15, 16).

In the preferred embodiment of the control method of the electromagnetic agitation device (2), the method includes a commutation phase between at least two operating modes of the electromagnetic agitation device (2), of which:
a first operating mode is a rotary operating mode in which the one or more second internal elements (19, 31) are in a deactivated condition and the first elements (11, 12, 13, 14, 15, 16) are driven with a three-phase tern of currents according to a configuration in which each of the first elements (11, 12, 13, 14, 15, 16) is driven with a respective shifted current with respect to another previous or next element of the first elements (11, 12, 13, 14, 15, 16) with respect to a deposition sequence of the elements on the assembly plane (28), in such a way that the molten metal is in rotational condition around a central axis (18) of the furnace according to a first rotation direction;
a second operating mode is a linear operating mode in which the one or more second internal elements (19, 31) are in an activated condition together with the first elements (11, 12, 13, 14, 15, 16), the one or more second internal elements (19, 31) and the first elements (11, 12, 13, 14, 15, 16) being driven with a three-phase tern of currents according to a configuration in which at least one of the one or more second internal elements (19, 31) is driven with a respective shifted current with respect to corresponding driving currents of one or more elements of the first series (29) of the first elements (11, 12, 13, 14, 15, 16) in such a way that the molten metal is in rotational condition around different rotation zones with generation of more than one different circulation movements inside the furnace in which each circulation movement has a first rotation direction.

Furthermore, the method may include a reversal phase of the rotary operating mode in which the first elements (11, 12, 13, 14, 15, 16) are driven with a three-phase tern of currents according to a configuration in which each of the first elements (11, 12, 13, 14, 15, 16) is driven with a respective shifted current with respect to another previous or next element of the first elements (11, 12, 13, 14, 15, 16) with respect to a deposition sequence of the elements on the assembly plane (28), in such a way that the molten metal is in rotational condition around the central axis (18) of the furnace according to a second rotation direction which is opposite with respect to the first rotation direction.

Furthermore, the method may include a reversal phase of the linear operating mode in which the one or more second internal elements (19, 31) and the first elements (11, 12, 13, 14, 15, 16) are driven with a three-phase tern of currents according to a configuration in which at least one of the one or more second internal elements (19, 31) is driven with a respective shifted current with respect to corresponding driving currents of one or more elements of the first series (29) of the first elements (11, 12, 13, 14, 15, 16) in such a way that the molten metal is in rotational condition around different rotation zones with generation of more than one different circulation movements inside the furnace in which at least one circulation movement has a second rotation direction opposite to the first rotation direction.

The present invention also relates to a melting furnace (1) of metallic material, in which the furnace (1) includes an electromagnetic agitation device (2) placed below with respect to a wall (7) at a bottom of the melting furnace (1) in such a way that a force field (9) of the electromagnetic agitation device (2) is at least partially situated inside the melting furnace (1) for electromagnetic agitation action on molten metal contained inside the melting furnace (1), in which the electromagnetic agitation device (2) is controlled according to a control method of the electromagnetic agitation device (2) made as described.

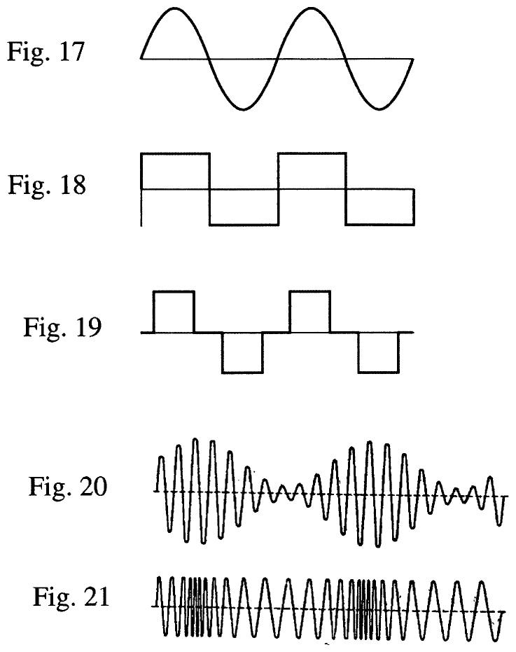

The elements (11, 12, 13, 14, 15, 16, 19) of generation of the force field (9) can be driven with currents which are controlled by means of a control signal which can be pure sinusoidal (FIG. 17) or non sinusoidal (FIG. 18, FIG. 19, FIG. 20, FIG. 21). For example, the elements (11, 12, 13, 14, 15, 16, 19) of generation of the force field (9) can be driven with a current which is controlled by means of a control signal which is a regular square wave (FIG. 18). For example the elements (11, 12, 13, 14, 15, 16, 19) of generation of the force field (9) can be driven with a current which is controlled by means of a control signal which is a square wave of the type usually indicated with modified sinusoidal wave (FIG. 19) which is a wave shape provided with steps having similar characteristics as a pure sinusoidal wave, with positive portions of square wave separated by negative portions of square wave by means of gaps with no current supply. For example, the elements (11, 12, 13, 14, 15, 16, 19) of generation of the force field (9) can be driven with a current which is controlled by means of a control signal which is an amplitude modulated sinusoidal wave (FIG. 20). For example, the elements (11, 12, 13, 14, 15, 16, 19) of generation of the force field (9) can be driven with a current which is controlled by means of a control signal which is a frequency modulated sinusoidal wave (FIG. 21). In general, therefore, it is provided that the device includes a current control system of the elements (11, 12, 13, 14, 15, 16, 19) of generation of the force field (9) in which the current control system provides a current which is proportional to a control signal which is selected between control signal in the form of pure sinusoidal wave and non pure sinusoidal wave. In relation to the inventive method, in an analogue way, a control phase is provided by means of a current control systems of the elements (11, 12, 13, 14, 15, 16, 19) of generation of the force field (9) in which the control phase controls the current provided in such a way that it is a current proportional to a control signal which is selected between control signal in the form of pure sinusoidal wave and non pure sinusoidal wave. Such solutions are advantageous because by means of wave shapes which are different from the pure sinusoidal one it is possible to obtain a lower energy consumption by obtaining the same mixing effect which would be obtained with a pure sinusoidal shape.

The description of the present invention has been made with reference to the enclosed figures in one of its preferred embodiments, but it is evident that a lot of possible changes, modifications and variations will be immediately clear to those skilled in the art in the light of the previous description. Thus, it must be underlined that the invention is not limited to the previous description, but it includes all the changes, modifications and variations in accordance with the appended claims.

### NOMENCLATURE USED

With reference to the identification numbers in the enclosed figures, the following nomenclature has been used:
1. Furnace
2. Agitation device or stirrer
3. Control unit
4. Electrode
5. Molten metal
6. Movement direction
7. Wall
8. Refractory
9. Force field
10. Tapping hole
11. First component
12. Second component
13. Third component
14. Fourth component
15. Fifth component
16. Sixth component
17. Longitudinal axis of the furnace
18. Central axis of the furnace
19. Seventh component
20. Support
21. Perimetric portion
22. Central portion
23. Casing
24. Winding
25. Nucleus
26. Conductor
27. Central axis of the agitation device or stirrer
28 Assembly plane
29. First series
30. Second series
31. Eight component
32. Transverse axis of the furnace

1. Electromagnetic agitation device for a melting furnace of metallic material, in which the agitation device is intended to be installed below the melting furnace, in which below is referred with respect to the direction of gravity, the agitation device being intended to be installed at a bottom of the melting furnace in such a way that a force field of the electromagnetic agitation device is at least partially situated inside the melting furnace for electromagnetic agitation action on molten metal contained inside the melting furnace, the agitation device being intended to placed below the furnace according to a configuration in which a central axis of the agitation device is positioned in the proximity of a central area of the furnace, in which the agitation device comprises elements in which each element is configured for generation of a respective electromagnetic field, in which the element is composed of a quadrangular magnetic nucleus on which a winding is present for passage of current and generation of a respective magnetic field, the agitation device comprising a control unit for controlling the agitation device in which the electromagnetic agitation device comprises at least one first series of first elements for application of reciprocally shifted alternating currents of generation of the force field, which are placed according to a shape in which the first elements of the first series are placed one after the other on an assembly plane, in which the assembly plane is intended to be parallel to the bottom of the melting furnace when the electromagnetic agitation device is in the installed condition at the bottom of the melting furnace, the first elements being placed around a central axis of the agitation device which is an orthogonal central axis with respect to the assembly plane, each winding being composed of at least one conductor wound on the magnetic nucleus so that a winding plane is parallel to the assembly plane, the first elements being placed along a closed path which develops on the assembly plane, the closed path being a circular, elliptical, quadrangular, or polygonal shape defined by the sequence of first elements placed one after the other on the assembly plane, wherein the electromagnetic agitation device further comprises one or more further second internal elements of generation of the force field further with respect to the first elements of the first series, in which the one or more second internal elements are placed internally with respect to the ensemble of the first elements of the first series and wherein the first elements (11, 12, 13, 14, 15, 16) of the first series (29) are placed on the assembly plane (28) according to a central symmetry arrangement with respect to the central axis (27) of the agitation device, in which the central axis is centrally passing with respect to the closed path along which the first elements (11, 12, 13, 14, 15, 16) of the first series (29) are placed, each of the first elements of the first series being placed on the assembly plane according to an arrangement in which each of the first elements is oriented in such a way that a major axis of the quadrangular shape of the magnetic nucleus is tangentially placed with respect to the closed path arrangement of the first series of first elements.

2. (canceled)

3. (canceled)

4. Electromagnetic agitation device according to claim 1, wherein four of said first elements of the first series are placed on the assembly plane according to a cross arrangement with a first pair of first elements placed at opposite ends of a first arm of the cross arrangement and a second pair of first elements placed at opposite ends of a second arm of the cross arrangement.

5. Electromagnetic agitation device according to claim 4, wherein a cross centre between first arm and second arm of the cross arrangement coincides with the central axis of the agitation device.

6. Electromagnetic agitation device according claim 1, wherein six of said first elements of the first series are placed on the assembly plane according to a hexagon arrangement with a first pair of first elements placed on a first couple of opposite sides of the hexagonal arrangement, a second pair of first elements placed on a second couple of opposite sides of the hexagonal arrangement, a third pair of first elements placed on a third couple of opposite sides of the hexagonal arrangement.

7. Electromagnetic agitation device according to claim 1, wherein the first elements of the first series are controlled by the control unit in an independent way one another for application of reciprocally shifted alternating currents for generation of the force field in such a way that the force field induces movements on the metallic material contained inside the melting furnace, which are configurable according to different sequences of application of the reciprocally shifted alternating currents independently applied on the first elements of the first series.

8. Electromagnetic agitation device according to claim 1, wherein the electromagnetic agitation device includes more than one of said further second internal elements of generation of the force field, in which said further second internal elements form a second series of second internal elements of generation of the force field, which are placed according to a shape in which the second internal elements of the second series are internally placed with respect to the ensemble of the first elements of the first series.

9. Electromagnetic agitation device according to claim 1, wherein the second elements of the second series are controlled by the control unit in an independent way one another for application of reciprocally shifted alternating currents for generation of the force field in such a way that the force field induces movements on the metallic material contained inside the melting furnace, which are configurable according to different sequences of application of the reciprocally shifted alternating currents independently applied on the second elements of the second series.

10. Electromagnetic agitation device according to claim 1, wherein the one or more further second internal elements are controlled by the control unit independently with respect to the first elements of the first series.

11. Electromagnetic agitation device according to claim 1, wherein the one or more further second internal elements are controlled by the control unit in a coordinated way together with the first elements of the first series for application of reciprocally shifted alternating currents for generation of the force field in such a way that the force field induces movements on the metallic material contained inside the melting furnace, which are configurable according to different sequences of application of the reciprocally shifted alternating currents applied in a coordinated way on the one or more further second internal elements of the second series and on the first elements of the first series.

12. Electromagnetic agitation device according to claim 11, wherein the control unit includes a commutation system between at least two operating modes of the electromagnetic agitation device, of which:
a first operating mode is a rotary operating mode in which the one or more second internal elements are in a deactivated condition and the first elements are driven with a three-phase tern of currents according to a configuration in which each of the first elements is driven with a respective Shifted current with respect to another previous or next element of the first elements, wherein previous or next is referred with respect to a deposition sequence of the elements on the assembly plane, in such a way that the molten metal is in rotational condition around a central axis of the furnace according to a first rotation direction;
a second operating mode is a linear operating mode in which the one or more second internal elements are in an activated condition together with the first elements, the one or more second internal elements and the first elements being driven with a three-phase tern of currents according to a configuration in which at least one of the one or more second internal elements is driven with a respective shifted current with respect to corresponding driving currents of one or more elements of the first series of the first elements in such a way that the molten metal is in rotational condition around different rotational zones with generation of more than one different circulation movements inside the furnace in which each circulation movement has a first rotation direction.

13. Electromagnetic agitation device according to claim 12, wherein the commutation system includes a system of rotary inversion of the motion of the first rotary operating mode in which the system of rotary inversion of the motion controls the shifted driving condition of the first elements in such a way that the molten metal is in rotational condition around the central axis of the furnace according to a second rotation direction which is opposite with respect to the first rotation direction.

14. Electromagnetic agitation device according to claim 12, wherein the commutation system includes a system of linear inversion of the motion of the second linear operating mode in which the system of linear inversion of the motion controls the shifted driving condition of the first elements and of the one or more second elements in such a way that the molten metal is in rotational condition around said different rotational zones with generation of more than one different circulation movements inside the furnace in which at least one circulation movement has a second rotation direction opposite with respect to the first rotation direction.

15. Electromagnetic agitation device according to claim 1, wherein it includes a current control system of the elements of generation of the force field in which the current control system provides a current which is proportional to a control signal which is selected between control signal in the form of pure sinusoidal wave and non pure sinusoidal wave.

16. Electromagnetic agitation device according to claim 15, wherein the control signal in the form of non pure sinusoidal wave is selected between regular square wave, square wave of the type usually indicated with modified sinusoidal wave which is a wave shape provided with steps with positive portions of square wave separated by negative portions of square wave by means of gaps with no current supply, amplitude modulated sinusoidal wave and frequency modulated sinusoidal wave.

17. Melting furnace of metallic material, in which the furnace includes an electromagnetic agitation device placed below the melting furnace, in which below is referred with respect to the direction of gravity, the agitation device being installed at a bottom of the melting furnace in such a way that a force field of the electromagnetic agitation device is at least partially situated inside the melting furnace for electromagnetic agitation action on molten metal contained inside the melting furnace, characterised in that the electromagnetic agitation device is made according to claim 1.

18. Control method of an electromagnetic agitation device for melting furnace of metallic material, in which the agitation device is intended to be installed below the furnace, in which below is referred with respect to the direction of gravity, the agitation device being intended to be installed at a bottom of the melting furnace in such a way that a force field of the electromagnetic agitation device is at least partially situated inside the melting furnace for electromagnetic agitation action on molten metal contained inside the melting furnace, in which the agitation device comprises elements in which each element is configured for generation of a respective electromagnetic field, in which the element is composed of a quadrangular magnetic nucleus on which a winding is present for passage of current and generation of a respective magnetic field, the agitation device comprising a control unit for controlling the agitation device, in which the electromagnetic agitation device comprises at least one first series of first elements of generation of the force field which are placed according to a shape in which the first elements of the first series are placed one after another on an assembly plane, in which the assembly plane is intended to be parallel to the bottom of the melting furnace when the electromagnetic agitation device is in the installed condition at the bottom of the melting furnace, the first elements being placed around a central axis of the agitation device which is an orthogonal central axis with respect to the assembly plane, each winding being composed of at least one conductor wound on the magnetic nucleus so that a winding plane is parallel to the assembly plane, in which the method includes a control phase of the first elements in which the first elements are driven with a three-phase tern of currents according to a configuration in which each of the first elements is driven with a respective shifted current with respect to another previous or next element of the first elements with respect to a deposition sequence of the elements on the assembly plane wherein the electromagnetic agitation device comprises one or more further second internal elements of generation of the force field further with respect to the first elements of the first series, in which the one or more second internal elements are internally placed with respect to the ensemble of the first elements of the first series, in which the method includes a coordinated control phase of the first elements and of the one or more second internal elements, in which the one or more second internal elements and the first elements are driven with a three-phase tern of currents according to a configuration in which at least one of the one or more second internal elements is driven with a respective shifted current with respect to corresponding driving currents of one or more elements of the first series of the first elements in which the electromagnetic agitation device is made according to claim 1.

19. (canceled)

20. Control method of electromagnetic agitation device according to claim 18, wherein it includes a commutation phase between at least two operating modes of the electromagnetic agitation device, of which:
a first operating mode is a rotary operating mode in which the one or more second internal elements are in a deactivated condition and the first elements are driven with a three-phase tern of currents according to a configuration in which each of the first elements is driven with a respective shifted current with respect to another previous or next element of the first elements, wherein previous or next is referred with respect to a deposition sequence of the elements on the assembly plane, in such a way that the molten metal is in rotational condition around a central axis of the furnace according to a first rotation direction;
a second operating mode is a linear operating mode in which the one or more second internal elements are in an activated condition together with the first elements, the one or more second internal elements and the first elements being driven with a three-phase tern of currents according to a configuration in which at least one of the one or more second internal elements is driven with a respective shifted current with respect to corresponding driving currents of one or more elements of the first series of the first elements in such a way that the molten metal is in rotational condition around different rotational zones with generation of more than one different circulation movements inside the furnace in which each circulation movement has a first rotation direction.

21. Control method of electromagnetic agitation device according to claim 20, wherein it includes an inversion phase of the rotary operating mode in which the first elements are driven with a three-phase tern of currents according to a configuration in which each of the first elements is driven with a respective shifted current with respect to another previous or next element of the first elements, wherein previous or next is referred with respect to a deposition sequence of the elements on the assembly plane, in such a way that the molten metal is in rotational condition around the central axis of the furnace according to a second rotation direction which is opposite with respect to the first rotation direction.

22. Control method of electromagnetic agitation device according to claim 20, wherein it includes an inversion phase of the linear operating mode in which the one or more second internal elements and the first elements are driven with a three-phase tern of currents according to a configuration in which at least one of the one or more second internal elements is driven with a respective shifted current with respect to corresponding driving currents of one or more elements of the first series of the first elements in such a way that the molten metal is in rotational condition around different rotational zones with generation of more than one different circulation movements inside the furnace in which at least one circulation movement has a second rotation direction opposite to the first rotation direction.

23. Control method of electromagnetic agitation device according to claim 18, wherein it includes a control phase by means of a current control system of the elements of generation of the force field in which the control phase controls the supplied current so that it is a proportional current to a control signal which is selected between control signal in the form of pure sinusoidal wave and non pure sinusoidal wave.

24. Control method of electromagnetic agitation device according to claim 23, wherein the control signal in the form of non pure sinusoidal wave is selected between regular square wave, square wave of the type usually indicated with modified sinusoidal wave which is a wave shape provided with steps with positive portions of square wave separated by negative portions of square wave by means of gaps with no current supply, amplitude modulated sinusoidal wave and frequency modulated sinusoidal wave.

25. (canceled)
